(19) United States
(12) Patent Application Publication
(10) Pub. No.: US 2010/0067320 A1
(43) Pub. Date: Mar. 18, 2010

(54) MULTI-SHAFT EXTRUDER

(76) Inventors: Josef Blach, Laufen (DE); Michael Blach, Laufen (DE); Markus Blach, Laufen (DE)

Correspondence Address: FLYNN THIEL BOUTELL & TANIS, P.C., 2026 RAMBLING ROAD, KALAMAZOO, MI, 49008-1631, US

(21) Appl. No.: 12/312,364

(22) PCT Filed: Sep. 13, 2007
(86) PCT No.: PCT/EP2007/007961

§ 371 Date: Nov. 30, 2009

(30) Foreign Application Priority Data
Nov. 8, 2006 (DE) 10 2006 052 610.4

(51) Int. Cl. B01F 7/00

(52) U.S. Cl. 366/85; 366/84

(57) ABSTRACT

A multi-shaft extruder has between an exterior housing (9) and an interior housing (10) at least six worm shafts (4) disposed in a circle (7). The drive (1) of the multi-shaft extruder has two pinion shafts (2) which are partitioned into groups of identical design and disposed on a circle (7), the pinion shafts being radially driven from the inside and from the outside at equal forces and in the same direction and in diametrical opposition and coaxially connected to the worm shafts (4) of the process part (5) via couplings (3), the worm shafts (4) having a feed length (L) of at least six Do and a Do/Di ratio of 1.5 to 1.93, wherein Do is the outside diameter and Di is the inside diameter of the feed screws (11, 12, 13) and the torque density of the extruder is at least 50 Nm/cm³.

The invention relates to an extruder consisting of a drive and a process part securely connected thereto with a plurality of worm shafts disposed in a circle according to the preamble of claim 1 for the continuous preparation of substances.

The mechanical and thermal preparation of substances using an extruder is in many cases carried out in a plurality of stages through combinations, distributed over the process length, of feed portions for mixing, melting, wetting, dispersing, degassing, reacting, etc. In this case, different substances in different form and consistency as granules, fibres, powders, etc., which are at least partly viscous to plastically deformable, are supplied, processed and extruded in a plastic, temperature-controlled process to form shaped articles, for example a profile, or to form unshaped granules. If the product is supplied to the extruder at room temperature, the bulk of the energy is required for heating and plasticising. The remaining procedural processing requires, on the other hand, only a small proportion of energy.

According to EP 0 852 533 B1, a torque density of at least 11 Nm/cm³ is used for tightly meshing twin screw extruders which rotate in the same direction and have a screw outside diameter Do and a screw inside diameter Di having a Do/Di ratio between 1.4 and 1.6 and at rotational speeds above 600 rpm, the torque density being the ratio of the torque per shaft relative to the axial distance³ (Md/a³). When equipping twin screw extruders with a supporting shaft and a push-on system of the feed elements having a Do/Di of 1.55, the torque density according to the prior art, at 14 Nm/cm³ per shaft, is a limit value which is also limited by the strength of the supporting shaft. Based on an extruder with two corresponding shafts, a torque density of 28 Nm/cm³ is thus obtained.

Furthermore, the efficiency of an extruder with the same supporting shaft system is capable of being increased if use is made, in accordance with the article by Frank Vorberg in Kunststoffe 8/2000, of a multi-shaft extruder according to the preamble of claim 1 with twelve shafts. The technical data mentioned in this article lead to the calculation, at a Do/Di ratio of 1.55, of, as design data, a torque density Md/a³ per shaft of just 5 Nm/cm³ and relatively low loading of the shaft. However, compared to the efficiency with the twin screw, the torque density of the multi-shaft extruder is, at 60 Nm/cm³, twice as high.

EP 1 425 151 B1 describes the process part of a multi-shaft extruder with at least four completely self-cleaning worm shafts which rotate in the same direction and have a Do/Di ratio of 1.3 to 1.7 for the preparation of a polycondensate. Owing to the high mechanical/thermal loading of the product, the rotational speed is limited to 600 rpm, although the torque density per shaft is at least 9 Nm/cm³, meaning 36 Nm/cm³ in the case of four shafts in the comparison of machines.

The object of the invention is to provide a multi-shaft extruder combining high cost-effectiveness with high product quality and broad applicability.

According to the invention, this is achieved by the multi-shaft extruder characterised in claim 1. Advantageous configurations of the invention are represented in the sub-claims.

The extruder according to the invention has a drive for at least six shafts which are disposed in a circle and, via couplings, drive the coaxially disposed shafts so as to rotate in the same direction in the process part for feeding and for building up pressure. The axial length of the process part is at least 6 Do.

According to the invention, the multi-shaft extruder has at least six shafts disposed on a pitch circle. In the case of six shafts, an arrangement in the closed pitch circle is generally possible, so that the shafts are disposed in an annular space between the exterior housing and the interior housing of the process part. The crucial advantage of this is the ideal balance of the active forces both in the system of the process part, and most particularly for the drive system, where the machine torque is generated as the first basic variable for economy and product quality.

This requires the introduction of the torque of the drive into the shafts via the pinions free from flexural loads. This takes place as a result of a radially opposing engagement of the gear wheels at the same force into the pinions positioned therebetween. As a result, not only is the load on the radial bearings of the shafts relieved, but above all the flexural fatigue load acting on the shafts is eliminated, thus allowing the permissible torque to be significantly increased. For the purpose of designing the pinions with the largest possible tip diameter, the pinion of every other shaft is axially offset by somewhat more than the width of the pinion and the width of the radial bearing, so that the tip diameter of the pinion plus the diameter of the shaft plus play is obtained as the smallest axial distance.

According to the invention, the process part, which is connected to the gear mechanism, has a plurality of feed shafts which are disposed in a circle and are surrounded by one or more exterior housing portions. In a first portion the feed shafts are occupied by particularly tightly meshing screws which have a length of 0.25 to 2 Do and are also tightly surrounded by the housing over the entire circumference to separate the process space on the inside from the air space on the outside. The first portion is followed by a second portion with feed screws which have a length between 2.0 and 6 Do and are surrounded by a partially non-tight housing which is open relative to the air space. The second portion is followed by a third screw portion which is at least 1.25 Do long and has radially and axially tightly meshing screws to build up pressure in order to supply the product in a fourth portion to a feed structure having, while forming end faces, with cam discs or screw portions which are progressively angularly offset relative to one another and have any desired pitch, at a minimum length of 1 Do and for each Do length, a free radial passage cross section in the pitch circle, from the outside to the inside, of at least ¼, in particular ⅓ of the free feed area (cf. EP 0 422 272 B2 and DE 102 07 145 A1). This gives rise to a radial substance and pressure compensation from flight to flight that is particularly intensive as a result of the free end faces, which are disposed in an angularly offset manner, of the individual elements or portions disposed in an angularly offset manner. The individual elements or portions of the one-piece element forming the feed structure can be embodied in the same or a different manner, individually or multiply in succession, or be disposed offset at the same or different angle relative to one another. Thus, in the case of double-flighted screws, the angular offset may be 90°+/−60°. The end faces, which become free and formed as a result of the angular offset, can be embodied perpendicularly, for example extend in a feed structure formed from cam discs or at an angle relative to the axis of the shaft.

This shaft portion can be adjoined by a fifth shaft portion which has a length of at least 0.25 Do and is additionally embodied as a pressure consumer. As a result of the pressure consumer, a flow resistance is generated and thus additionally the material is piled up. The pressure consumer can be formed by feeding or refeeding screw elements, refeeding working elements, or retarding discs and the like. To generate the required resistance, the pressure consumer has a length of at least 0.25 Do.

The outside diameter of the pressure consumers can be equal to or greater than the axial distance between adjacent shafts; however, it is at most as great as the outside diameter Do of the feed screws.

The ratio Do/Di is, for double and/or single-flighted feed screws, in particular 1.50 to 1.93, preferably 1.6 to 1.93. The feed structure has the same preferred Do/Di ratio. The torque density Md/a³, based on the machine, of the extruder according to the invention is at least 50, preferably at least 100, in particular at least 160, and particularly preferably at least 220 Nm/Cm³, to attain the desired high specific power.

The portions of the feed screws and housing can also consist of one or more identical or different elements disposed one after another. Thus, a double-flighted feed screw rising to the right can be identically and/or differently cut free, in a single-flighted and/or double-flighted manner rising to the left, wholly or partly to the length and/or the flight depth and vice versa, as a result of which islands are left from the screw ridge.

As the shafts are disposed in a closed circle, an independent interior space is produced, which is substantially tightly surrounded by the worm shafts. Part of the interior space is filled by the interior housing, the exterior shape of which is provided with concave depressions in accordance with the outside diameter of the worm shafts. In this case, the pressure consumer is preferably not tightly surrounded by the interior housing on at least one shaft over a length of at least 0.25 Do. In addition, the concave depressions of the interior housing may be omitted over the corresponding length.

This measure is effective especially when the interior housing is designed so as to be able to be positioned axially differently. Thus, the region of the interior housing that does not tightly surround the pressure consumer can be positioned out therefrom axially into the region of a pressure consumer, so that the effect of the pressure consumer, i.e. for example of the refeeding screw elements, is strengthened and at the same time if possible that of the pressure generators is weakened, so that the filling level and the residence time rises and thus more energy is introduced into the product, or vice versa. In this case, the interior housing can be axially positioned identically or in each case differently from at least one end of the exterior housing as a whole or in certain portions, for example by offsetting or displacing the non-tightly surrounding region of the interior housing in the axial direction.

The interior housing is preferably embodied so as to be coolable and the exterior housing so as to be heatable and coolable. The exterior housing and/or the interior housing can be embodied with one or more shells. The exterior housing can have, in addition to the first and second housing partial piece, one or more further housing pieces having a length of preferably 2 to 10 Do, which can be positioned relative to one another, held tightly together and designed with or without radially closed openings, wherein the closures can be designed so as to be exchangeable or radially adjustable and disposed distributed one after another over the circumference or the length. In particular, one or more openings in the circumference of the exterior housing, which openings are distributed in one or more radial planes, can be provided at the circumference for supplying and/or discharging substances. These openings can be disposed, for example for the supply, with or without a supply device, of powders or continuous fibres, optionally in a plurality of strands or gas discharge line at the circumference of the exterior housing symmetrically, in single or multiple opposition, horizontally and/or at an angle.

The extruder according to the invention is suitable not only for melting and degassing substances, but in particular for wetting nano-sized solids to continuous fibres, for incorporating into plastics materials and similar extrudable materials with high economy and quality. The reason for this is that the machine provides, as a result of its high torque density, along with the introduction of energy which is adaptable to very different requirements, also higher melting power at a relatively lower circumferential velocity and thus material temperature.

The invention will be described hereinafter in greater detail by way of example and with reference to be appended drawings, in which:

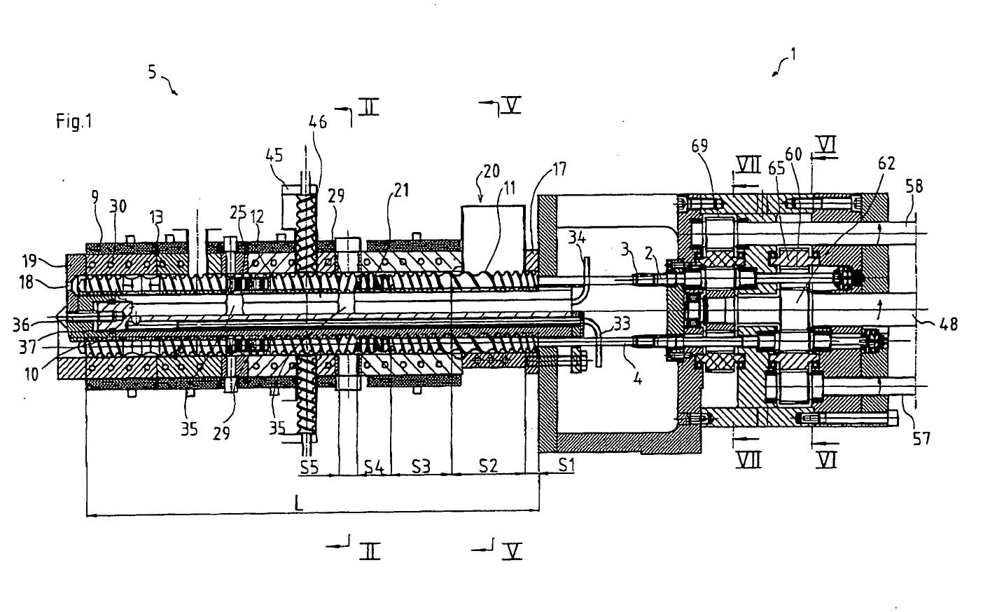

FIG. 1 is a longitudinal section through the multi-shaft extruder;

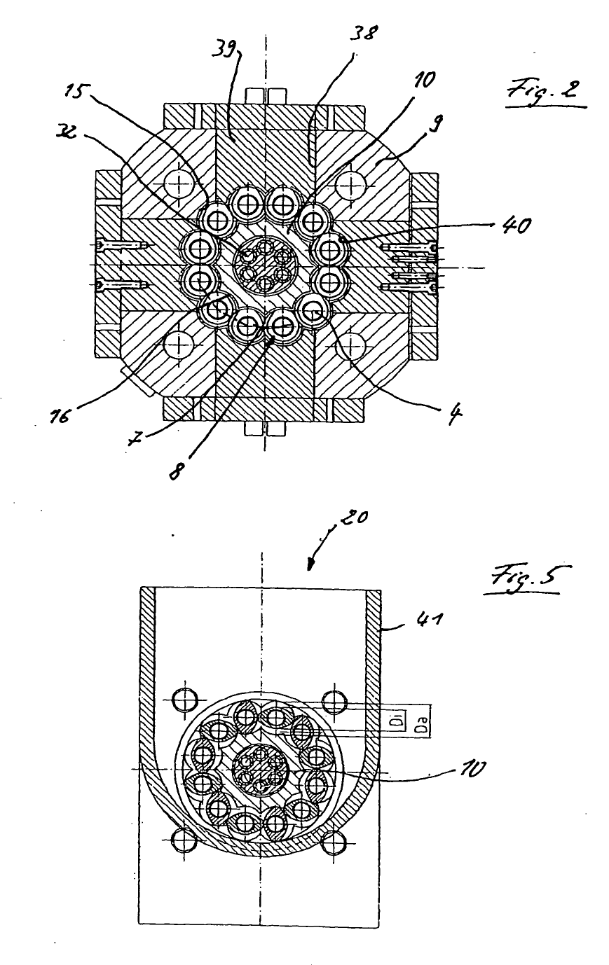

FIG. 2 is a section through the extruder along the line II-II according to FIG. 1;

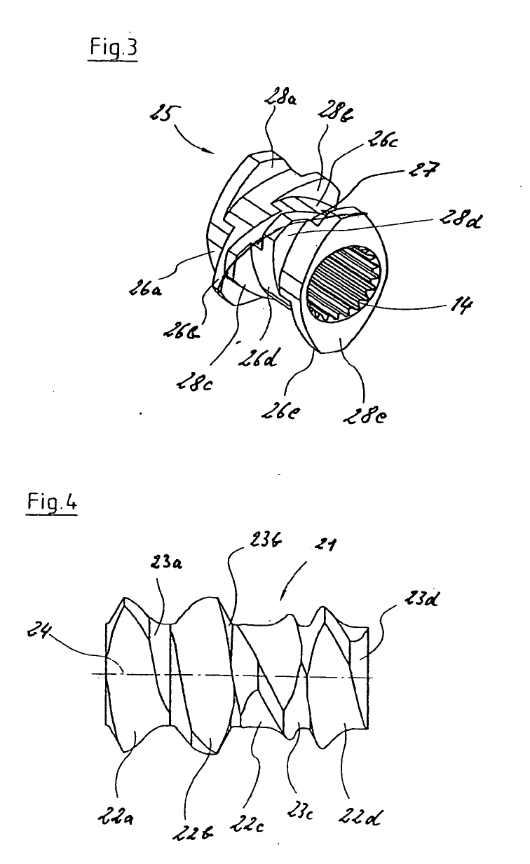

FIGS. 3 and 4 are a perspective view and side view respectively onto a kneading block and another embodiment of the feed structure;

FIG. 5 is a section along the line V-V in FIG. 1; and

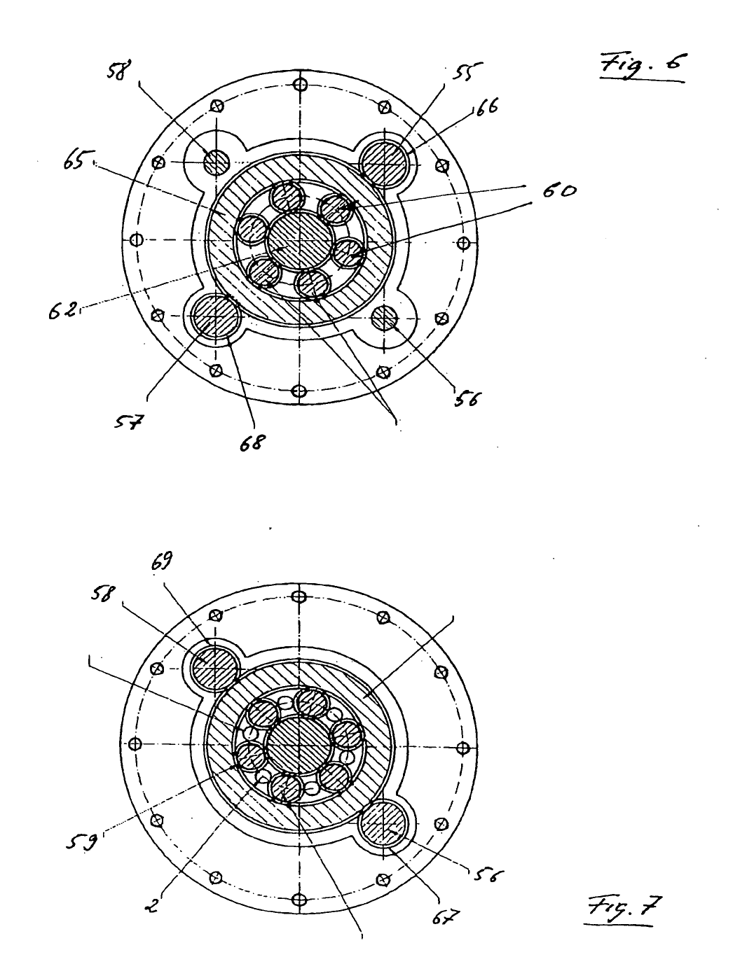

FIGS. 6 and 7 are a section through the drive of the extruder along the line VI-VI and VII-VII respectively in FIG. 1.

According to FIG. 1, the multi-shaft extruder consists of a drive 1 with twelve pinion shafts 2 which are disposed on a circle and are connected to the worm shafts 4 of the process part 5 via couplings 3.

According to FIG. 2, the twelve shafts 4 of the process part 5 are disposed in an axis-parallel manner on a pitch circle 7 in an annular space 8 between an exterior housing 9 and an interior core or interior housing 10 and rotate in the same direction. The worm shafts 4 are non-rotatably connected to interlocking feed screws 11, 12, 13 and other elements. For this purpose, they are pushed onto the shafts 4 via a serration 14 (cf. FIG. 3).

According to FIG. 2, the exterior housing 9 is provided on the inside with axis-parallel concave circular segments 15. Likewise, the interior housing 10 has axis-parallel concave circular segments 16. The circular segments 15, 16 receive the respective shaft 4 and guide it.

According to FIG. 1, one end of the exterior housing 9 is closed on the upstream feed side by an end plate 17. Furthermore, a plurality of material outlet openings 18 are provided in the downstream feed-side end plate 19.

The axial feed length L of the process part 5 is for example 20 Do, wherein Do is the outside diameter of the feed screws 11, 12, 13.

The process part 5 has, in connection to the end plate 17, a first portion S1 having a length of for example 0.5 Do, which is tightly surrounded by the exterior housing 9 and the interior housing 10 and provided with tightly meshing feed screws 11. The first portion S1 is adjoined by a second portion S2 having a length of for example 6 Do, in which feed screws 11 are likewise provided. In the portion S2 the exterior housing 9 is provided with the material supply opening 20 to a length of for example 5 Do, so that the feed screws 11 are surrounded in the portion S2 by a partially non-tight exterior housing 9.

The second portion S2 is adjoined by a third portion S3 having a length of for example 4 Do, which is tightly surrounded by the exterior housing 9 and the interior housing 10 and in which the feed screws 11 are likewise embodied in a tightly meshing manner. The third portion S3 is followed by a fourth portion S4 having a length of for example 2 Do with a feed structure 21. According to FIG. 4, the feed structure 21 is formed by a one-piece element consisting of short screw portions 22a to 22d which are disposed progressively angularly offset relative to one another. As a result, free end faces 23a to 23d are formed, which are inclined relative to the axis 24 of the shaft.

FIG. 3 shows another embodiment of a feed structure 25, namely a kneading block consisting of cam disc portions 26a to 2e which are disposed, as indicated by the line 27, likewise with a pitch direction corresponding to the feed screws 11 to 13, thus forming free end faces 28a to 28e which are perpendicular to the axis of the shaft. The radially free passage cross section in the pitch circle 7, from outside to inside, is, in the feed structures 21 and 25, at least one quarter, in particular at least one third of the machine feed area.

According to FIG. 1, the fourth portion S4 is adjoined by a fifth portion S5 in which the shafts 4 are provided with a pressure consumer. The pressure consumer generates high flow resistance and thus piles up the material. The pressure consumer can be formed, as illustrated in FIG. 1, by refeeding screw elements 21, but also by refeeding working elements, such as refeeding kneading blocks, retarding discs or the like. It can also be formed by feeding screws or screw or working elements. To generate the required build-up of pressure, the fifth portion S5 has a length of at least 0.25 Do.

According to FIG. 1, the exterior housing 9 is provided with channels 30 through which a hot or cold liquid is passed to heat and/or to cool the exterior housing 9. FIG. 2 shows that the interior housing 10 has axial bores 32 to heat and/or to cool it for example with a liquid which is supplied and discharged via the connections 33, 34.

As may be seen from FIG. 1, the concave depressions 16 are removed or omitted on the interior housing 10 in the region 35 of the refeeding screw elements 29 forming the pressure consumer. Thus, the pressure consumer is no longer tightly surrounded in these regions, i.e. the flow resistance which the refeeding screw elements 29 generate is reduced.

The interior housing 10 is mounted in a floating manner in the downstream feed-side end plate 19 facing the material outlet opening 18. For this purpose, the screw 36 is released, with which the interior housing 10 is fixed to the end plate 19 and the position of the region 35 of the interior housing 10 is adjusted for example with a spacer ring 37. This allows the flow resistance of the pressure consumer to be adjusted.

According to FIG. 2, the exterior housing 9 has in a radial plane four openings 38 which are distributed over the circumference and can each be closed by a stopper 39. The surface of the stoppers 39 that faces the interior housing 10 is likewise provided, in accordance with the circular segments 15 on the interior wall of the exterior housing 9, with concave circular segments 40. Thus, the effect of the pressure consumer in the region of the openings 38 can be altered by partly extracting the stoppers 39.

According to FIG. 5, the material supply opening 20 has a supply nozzle 41.

In addition, according to FIG. 1, further openings, on each of which an installation 45 with a feed screw 46 is disposed, can be provided in the exterior housing 9.

The worm shafts 4, which extend through the upstream feed-side end plate 17, are driven by the drive 1 so as to rotate in the same direction. According to FIG. 1, the drive 1 is connected to the end plate 17 of the process part 5 via a connection housing 47.

The drive 1 has a main drive shaft (not shown) which drives via a branching gear mechanism a drive shaft 48 which is positioned on the inside coaxially thereto and four external axis-parallel drive shafts 55 to 58.

A respective pinion 59, 60 is non-rotatably fastened to the pinion shafts 2 forming the output shafts of the drive 1, preferably by forming the shaft 2 and the pinion 59 and 60 respectively in one piece. The pinions 59, 60 of adjacent shafts 2 are disposed in an axially offset manner, i.e. the pinions 59 are disposed on the process part 5 closer than the pinions 60.

The central drive shaft 48 is non-rotatably provided with two axially offset, internal, externally toothed drive wheels 61, 62 which mesh with the pinions 59, 60. The pinions 59, 60 are driven both by the central, externally toothed drive wheels 61, 62 and by the comprising, internally toothed hollow wheel 64, 65 disposed radially opposite, which are in turn disposed in a correspondingly axially offset manner.

Each hollow wheel 64, 65 is provided with external toothing with which an externally toothed drive wheel 66 to 69 on the four external drive shafts 55 to 58 meshes. The external drive wheels 66 to 69 are disposed in an axially offset manner in accordance with the pinions 59, 60 or the internal drive wheels 61, 62 or the hollow wheels 64, 65.

The external drive wheels and, as illustrated, the additional drive wheels of the central drive shaft 48 can be driven by separate electric drive motors for each shaft, or with mechanical power branching.

The hollow wheels 64, 65 are thus centred in a substantially force-neutral manner by two respective external, diametrically opposite drive wheels 66, 68 and 67, 69 respectively. However, in principle, only one drive wheel is necessary for each hollow wheel.

Thus, the drive 1 has pinion shafts 2 which are partitioned into two groups of identical design and disposed on a circle 7, the pinion shafts being radially driven from the inside and from the outside at equal forces and in the same direction and in diametrical opposition and coaxially connected to the worm shafts 4 of the process part 5 via couplings 3.

1. Multi-shaft extruder consisting of a drive (1) and a process part (5) connected thereto with at least six axis-parallel worm shafts (4) which are disposed in a circle (7) between an exterior housing (9) and an interior housing (10), rotate in the same direction and are non-rotatably connected to interlocking feed screws (11, 12, 13) and other elements, the exterior housing (9) on the inside and the interior housing (10) being provided with axis-parallel, concave circular segments (15, 16) which receive the respective worm shaft (4) and with at least one material supply opening (20) at one end of the exterior housing (9) and at least one material outlet opening (18), characterised in that the drive (1) has two pinion shafts (2) which are partitioned into groups of identical design and disposed on a circle (7), the pinion shafts being radially driven from the inside and from the outside at equal forces and in the same direction and in diametrical opposition and coaxially connected to the worm shafts (4) of the process part (5) via couplings (3), the worm shafts (4) having a feed length (L) of at least six Do and a Do/Di ratio of 1.5 to 1.93, wherein Do is the outside diameter and Di is the inside diameter of the feed screws (11, 12, 13) and the torque density of the extruder is at least 50 Nm/cm³.

2. Multi-shaft extruder according to claim 1, characterised in that the torque density of the extruder is at least 100 Nm/cm³.

3. Multi-shaft extruder according to claim 1, characterised in that the torque density of the extruder is at least 160 Nm/cm³.

4. Multi-shaft extruder according to claim 1, characterised in that the torque density of the extruder is at least 220 Nm/cm³.

5. Multi-shaft extruder according to claim 1, characterised in that the Do/Di ratio is 1.6 to 1.93.

6. Multi-shaft extruder according to claim 1, characterised in that the interior housing (10) is disposed radially securely at one or both ends of the exterior housing (9) and so as to be axially adjustable from one or both ends of the exterior housing (9).

7. Multi-shaft extruder according to claim 1, characterised in that the process part (5) has at the end facing the drive (1) a first portion (S1) which has a length of 0.25 to 2 Do, is tightly surrounded by the exterior housing (9) and the interior housing (10) and provided with tightly meshing feed screws (11), which first portion is adjoined by a second portion (S2) which has a length of 2 to 12 Do and comprises feed screws (11) which are surrounded by a partially non-tight exterior housing (9) comprising the supply opening (20) having a length of at most 6 Do, followed by a third portion (S3) which has a length of at least 1.25 Do, is tightly surrounded by the exterior housing (9) and the interior housing (10) and provided with tightly meshing feed screws (11), which third portion is adjoined by a fourth portion (S4) which has a length of at least 1 Do and has, while forming end faces (23a to 23d, 28a to 28d), screw portions (22a to 22e) or cam discs (26a to 26e), which are progressively angularly offset relative to one another, and a radially free passage cross section in the partial circle (7) from the outside to the inside of at least ¼, in particular at least 1.3 of the free machine feed area.

8. Multi-shaft extruder according to claim 6, characterised in that the fourth portion (S4) is adjoined by a fifth portion (S5) which has a length of at least 0.25 Do and in which the shafts (4) act as pressure consumers.

9. Multi-shaft extruder according to claim 7, characterised in that the pressure consumers are feeding or refeeding screw elements or working elements or retarding discs.

10. Multi-shaft extruder according to claim 6, characterised in that the first portion (S1) and the second portion (S2) and the third portion (S3) have overall at most a length of 16 Do.

11. Multi-shaft extruder according to claim 6, characterised in that the first portion (S1) and the second portion (S2) and the third portion (S3) have overall at most a length of 12 Do.

12. Multi-shaft extruder according to claim 6, characterised in that the first portion (S1) and the second portion (S2) and the third portion (S3) have overall at most a length of 8 Do.

13. Multi-shaft extruder according to claim 6, characterised in that on the interior housing (10) the concave depressions (16) are at least partly omitted to a length of at least 0.25 Do, so that the pressure consumer is not tightly surrounded.

14. Multi-shaft extruder according to claim 13, characterised in that non-tight interior housing portions are surrounded by the pressure consumer at the same or different distances and in the same or different embodiments.

15. Multi-shaft extruder according to claim 1, characterised in that the feed screw has a double-flighted feeding or refeeding screw portion which, in a single and/or double-flighted manner in the feeding or refeeding screw direction at the same or different pitch, is wholly or partly cut free to the length and/or flight depth.

16. Multi-shaft exterior according to claim 1, characterised in that the interior housing (10) is embodied in one or more pieces and so as to be coolable and/or heatable in one or more zones.

17. Multi-shaft exterior according to claim 1, characterised in that the exterior housing (9) is embodied so as to be heatable and/or coolable and with one or more shells.

18. Multi-shaft extruder according to claim 1, characterised in that the exterior housing (9) has closable openings (38) which are distributed over its circumference and/or over its length for supplying and/or discharging substances with or without a supply device.
